(19) United States
(12) Patent Application Publication
(10) Pub. No.: US 2019/0001734 A1
(43) Pub. Date: Jan. 3, 2019

(54) PLASTIC CARD WITH ENHANCED LAMINATE ADHESION

(71) Applicant: Entrust Datacard Corporation, Shakopee, MN (US)

(72) Inventor: Gene Meier, Shakopee, MN (US)

(21) Appl. No.: 16/018,558

(22) Filed: Jun. 26, 2018

Related U.S. Application Data
(60) Provisional application No. 62/584,178, filed on Nov. 10, 2017.
(60) Provisional application No. 62/526,690, filed on Jun. 29, 2017.

(51) Int. Cl. B42D 25/47; B41M 5/40; B42D 25/387

(52) U.S. Cl. CPC B42D 25/47; B32B 7/12; B42D 25/387; B41M 5/40

(57) ABSTRACT

Improving the adhesion of a laminate on a plastic card where the laminate overlays a print receptor layer. The size of the laminate is made larger than the print receptor layer so that at least a portion of the perimeter edge of the laminate extends beyond the perimeter edge of the print receptor layer so that the portion of the perimeter edge is adhered or otherwise bonded directly to the surface of the plastic identification document substrate or to other material of or on the plastic identification document substrate other than the print receptor layer. This increases the difficulty in picking the edges of the laminate loose and peeling the laminate from the print receptor layer and from the plastic identification document substrate.

### FIELD

This disclosure relates to performing color printing on plastic substrates such as plastic card substrates or plastic passport page substrates, improving the adhesion of laminates to the plastic substrates, and creating new security features on the plastic substrates.

### BACKGROUND

When performing color printing (dye or pigment) on some plastic card substrates, for example substrates made from polycarbonate, a color printed directly onto the polycarbonate can result in undesirable image quality. One solution to this problem has been to apply a print receptor layer onto the plastic card substrate prior to performing the color printing, and then performing the color printing on the print receptor layer.

However, when a laminate is applied over the print receptor layer, the adhesion strength between the print receptor layer and the laminate is relatively weak. This makes the laminate relatively easy to remove from the print receptor layer and the card substrate, especially where an interface edge of the laminate where the laminate interfaces with the print receptor layer is accessible, rendering the card more susceptible to tampering.

For example, referring to FIG. 1, a plastic card 10 is illustrated that includes a card-shaped plastic substrate 12 with a major surface 14, for example an upper surface. A print receptor layer 16 (indicated in dashed line) is indicated as being applied to the major surface 14, and color printing 18 is applied to the print receptor layer 16. In addition, a laminate 20 (shown in solid line) is applied over the print receptor layer 16 and over the color printing 18. In situations where the laminate 20 is the same size as the print receptor layer 16 or smaller than the print receptor layer 16, an interface edge 22 of the laminate 20 that interfaces with the print receptor layer 16 is accessible. The low adhesion strength between the laminate 20 and the print receptor layer 16 and the accessibility of the interface edge 22 facilitates picking the interface edge 22 loose, thereby allowing the laminate 20 to be peeled off from the print receptor layer 16.

### SUMMARY

Techniques are described herein for improving the adhesion of a laminate on a plastic identification document substrate, such as a plastic card or plastic passport page, where the laminate overlays a print receptor layer. The size of the laminate is made larger than the print receptor layer so that at least a portion of the perimeter edge of the laminate extends beyond the perimeter edge of the print receptor layer so that the portion of the perimeter edge is adhered or otherwise bonded directly to the surface of the plastic identification document substrate or to other material of or on the plastic identification document substrate other than the print receptor layer. This increases the difficulty in picking the edges of the laminate loose and peeling the laminate from the print receptor layer and from the plastic identification document substrate.

In one embodiment, approximately 75% or more of the perimeter edge of the laminate extends beyond the perimeter edge of the print receptor layer and is adhered or otherwise bonded directly to the surface of the plastic identification document substrate or to other material of or on the plastic identification document substrate other than the print receptor layer. In another embodiment, the entire perimeter edge of the laminate extends beyond the perimeter edge of the print receptor layer and is adhered or otherwise bonded directly to the surface of the plastic identification document substrate or to other material of or on the plastic identification document substrate other than the print receptor layer so that no portion of the perimeter edge of the laminate interfaces with the print receptor layer.

Techniques are also described herein for creating new security features on plastic identification document substrates such as plastic cards or plastic passport pages. In one embodiment, both a printed image (monochromatic or multi-color) and a material with an ultraviolet (UV) fluorescent agent can be applied, for example by printing, on a surface of the plastic identification document substrate. In one embodiment, the material with the UV fluorescent agent can be a receptor layer, and the printed image can be printed at least partially onto the receptor layer. At least a portion of the receptor layer with the UV fluorescent agent is displaced from the printed image and forms a border along at least a portion of the printed image. When UV light shines on the receptor layer at the border, the receptor layer forming the border fluoresces or glows.

In one embodiment, the receptor layer can be printed in a shape that is the same as the printed image, but the shape of the receptor layer is larger than the printed image, and the printed image can be centered on the receptor layer so that a substantially constant border is created around the entire printed image by the receptor layer. When UV light shines on the receptor layer, the receptor layer forming the border fluoresces or glows.

The plastic identification document substrate can be any plastic or substantially plastic identification document that bears personal information or personalized data that is unique or personal to the intended document holder such as, but not limited to, the document holders name, address, account number, portrait photograph, or the like. Examples of plastic identification document substrates include plastic cards such as, but not limited to, financial (e.g., credit, debit, or the like) cards, driver's licenses, national identification cards, business identification cards, gift cards, and other plastic cards which bear personalized data unique to the cardholder and/or which bear other card information. The plastic cards can have an integrated circuit chip and/or a magnetic stripe each of which can store data including personalized data. In one embodiment, the plastic card can be an ID-1 card as defined by ISO/IEC 7810, with a length of about 85.60 mm (about 3⅜ inches) and a width of about 53.98 mm (about 2⅛ inches), and rounded corners with a radius of between about 2.88-3.48 mm. The plastic identification document substrate can also include a plastic passport page that has been or is intended to be incorporated into a passport.

### DRAWINGS

FIG. 1 is a top plan view of a conventional plastic card.

FIG. 2 is a top plan view of a plastic card with a laminate as described herein.

FIG. 3 is an enlarged view of the laminate and print receptor layer of FIG. 2.

FIG. 4 is a cross-sectional view taken along line 4-4 of FIG. 2.

FIG. 5 is a top plan view of another embodiment of a plastic card with a laminate as described herein.

FIG. 6 is a top plan view of still another embodiment of a plastic card with a laminate as described herein.

FIG. 7 is a top plan view of still another embodiment of a plastic card with a laminate as described herein.

FIG. 8 is a top plan view of an embodiment of a plastic card demonstrating the concept of a fluorescing or glowing security feature associated with a printed image.

FIG. 9 is a perspective top view of a plastic card illustrating the fluorescing security feature of FIG. 8.

FIG. 10 is a top plan view of another embodiment of a plastic card demonstrating the concept of another fluorescing or glowing security feature associated with a printed image.

FIG. 11 is a perspective top view of a plastic card illustrating the fluorescing security feature of FIG. 10.

FIG. 12 is a top plan view of another embodiment of a plastic card described herein.

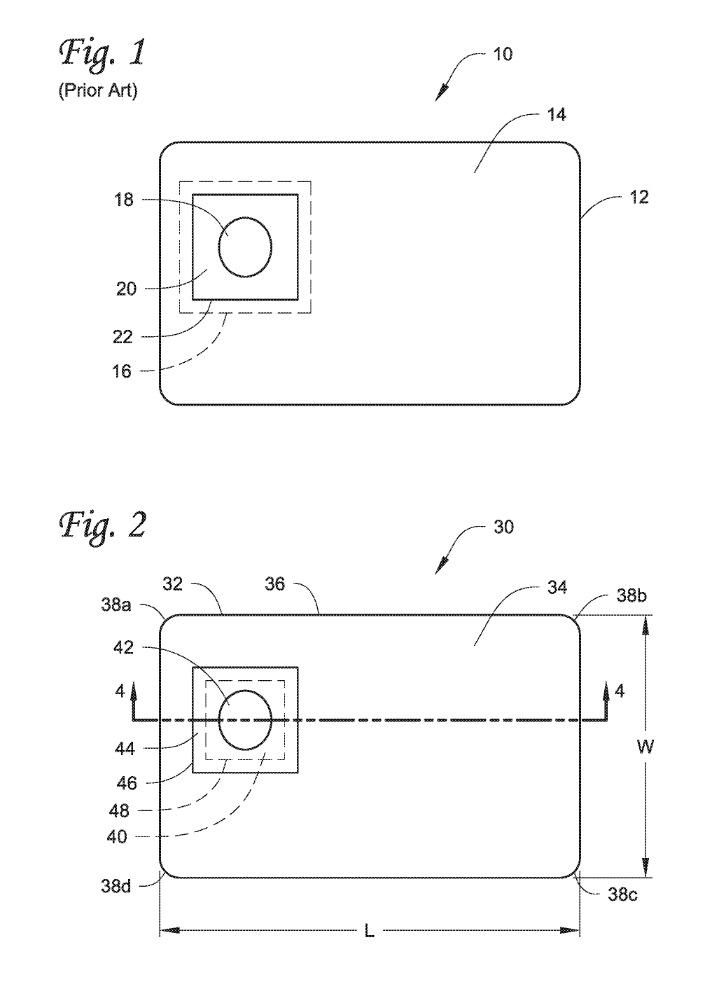

### DETAILED DESCRIPTION

A plastic identification document substrate as used herein refers to a plastic or substantially plastic identification document, such as a plastic card or plastic passport page, that bears personal information or personalized data that is unique or personal to the intended identification document holder such as, but not limited to, the identification document holders name, address, account number, portrait photograph, or the like. For convenience, the detailed description and drawings refer to and illustrate a plastic card. However, the concepts described herein can apply to a plastic passport page and other plastic identification document substrates.

The printing and laminating techniques described herein can be performed in what is referred to as a card processing system. The term “card processing system” is intended to encompass a system that personalizes cards as well as passports and other personalized documents. One example of a type of card processing system that can be used is referred to as a central issuance card processing system that is typically designed to simultaneously process multiple cards, for example on the order of thousands of plastic cards per hour, often employing multiple processing stations or modules, to reduce the overall per card processing time. Examples of central issuance card processing systems include the MX family of central issuance systems available from Entrust Datacard Corporation of Shakopee, Minn. Other examples of central issuance systems are disclosed in U.S. Pat. Nos. 4,825,054, 5,266,781, 6,783,067, and 6,902,107, all of which are incorporated herein by reference in their entirety.

Another example of a type of plastic card processing system that can be used is referred to as a desktop card processing system that is typically designed for relatively small scale, individual plastic card processing. In desktop processing systems, a single plastic card to be processed is input into the system, processed, and then output. These systems are often termed desktop machines or desktop printers because they have a relatively small footprint intended to permit the machine to reside on a desktop. Many examples of desktop machines are known, such as the SD or CD family of desktop card machines available from Entrust Datacard Corporation of Shakopee, Minn. Other examples of desktop card machines are disclosed in U.S. Pat. Nos. 7,434,728 and 7,398,972, each of which is incorporated herein by reference in its entirety.

Referring to FIG. 2, a plastic card 30 is illustrated that includes a card-shaped plastic substrate 32 with a first major surface 34, a second major surface 35 (see FIG. 4) opposite the first major surface 34, a perimeter edge 36, a length L, a width W, and rounded corners 38a-d. In some embodiments, the first major surface 34 can be referred to as an upper or front surface of the card 30 and the second major surface 35 can be referred to as a lower or rear surface of the card 30. In other embodiments, the first major surface 34 can be referred to as the lower or rear surface of the card 30 and the second major surface 35 can be referred to as the upper or front surface of the card 30. In some embodiments, the plastic card 30 can be a financial card such as a credit card, debit card, or the like that can have an integrated circuit chip and/or a magnetic stripe each of which can store data including personalized data.

A print receptor layer 40 (indicated in dashed line) is indicated as being applied to the first major surface 34, and color printing 42 is applied to the print receptor layer 40. In addition, a laminate 44 (shown in solid line) is applied over the print receptor layer 40 and over the color printing 42. The color printing 42 can be dye or pigment printing including, but not limited to, thermal printing such as dye diffusion or mass transfer printing.

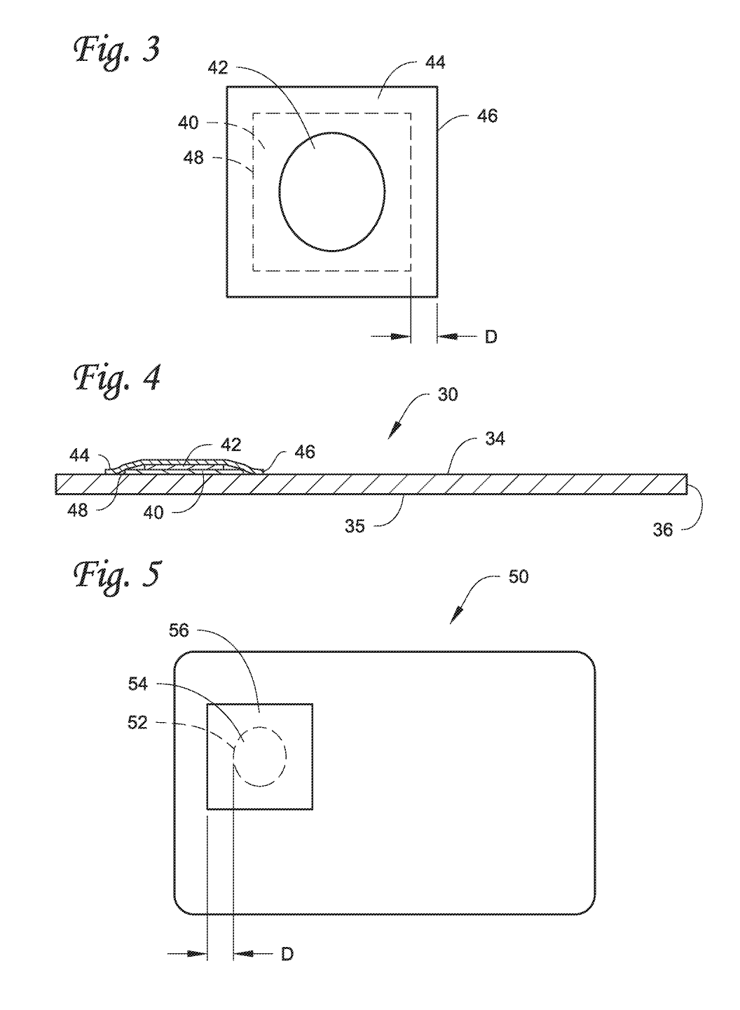

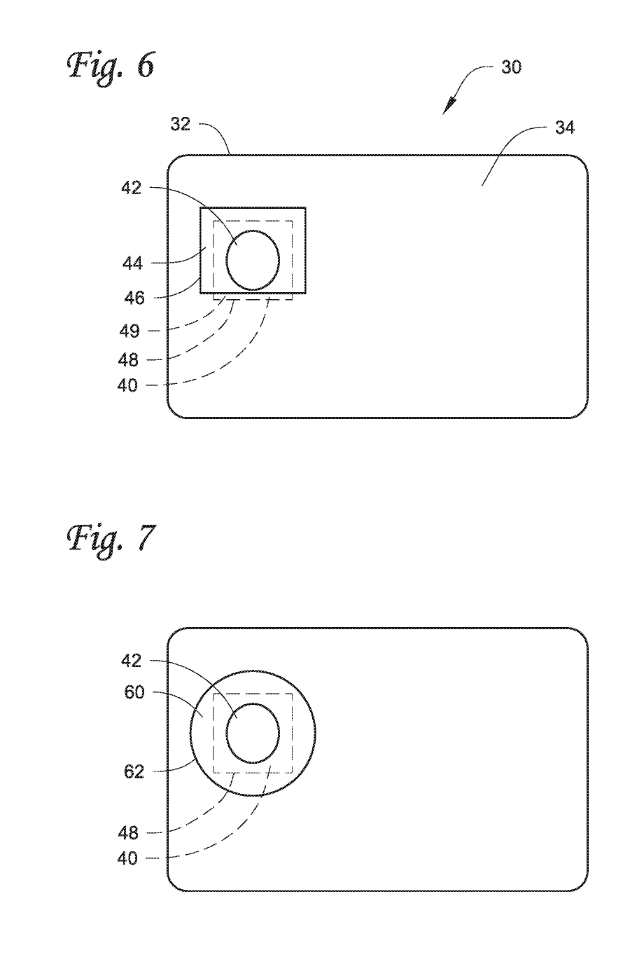

The laminate 44 is larger in size than the print receptor layer 40 so that at least a portion of a perimeter edge 46 of the laminate 44 extends beyond a perimeter edge 48 of the print receptor layer 40. The portion of the perimeter edge 46 of the laminate 44 that extends beyond the perimeter edge 48 of the print receptor layer 40 is adhered or otherwise bonded directly to the surface 34 of the card 30 or to other material of or on the card 30 other than the print receptor layer 40. In one embodiment, approximately 75% or more of the perimeter edge 46 of the laminate 44 extends beyond the perimeter edge 48 of the print receptor layer 40. FIGS. 2 and 3 illustrate an embodiment where the entirety of the perimeter edge 46 of the laminate 44 extends beyond the perimeter edge 48 of the print receptor layer 40. FIG. 6 illustrates another embodiment where only a portion of the perimeter edge 46 (i.e. less than the entire perimeter edge 46) of the laminate 44 extends beyond the perimeter edge 48 of the print receptor layer 40 whereby a portion 49 of the print receptor layer 40 is not covered by the laminate 44.

Referring to the embodiment in FIGS. 3 and 4, the perimeter edge 46 of the laminate 44 overhangs the perimeter edge 48 of the print receptor layer 40 by a substantially constant distance D over the entire area of the laminate 44. The thicknesses of the print receptor layer 40, the printing 42, and the laminate 44 are exaggerated in FIG. 4 in order to better illustrate the various features. In one embodiment, the distance D is at least equal to or greater than about 2.0 mm. In another embodiment, the distance D is at least equal to or greater than about 1.0 mm. In another embodiment, the distance D can be from about 1.0 mm to about 10 mm, and in another embodiment the distance D can be from about 2.0 mm to about 5.0 mm. In the embodiment of FIGS. 2-4, the color printing 42 is illustrated as occupying less than the entire area of the print receptor layer 40. However, the color printing 42 could occupy the entire area of the print receptor layer 40 as described with respect to FIG. 5.

The laminate 44 can have any size whereby at least a portion, for example at least 75% or more or the entirety, of the perimeter edge 46 of the laminate 44 is adhered or otherwise bonded directly to the first major surface 34 of the substrate 32 or to other material of or on the plastic card 30 other than the print receptor layer 40. In the example illustrated in FIGS. 2-4, the laminate 44 is shown as being larger in size than the print receptor layer 40, but smaller in size than the first major surface 34. When the printing 42 is a photograph of the intended cardholder, the laminate 44 can be referred to as a patch laminate or just patch. An example of a patch laminate is disclosed in US Patent Application Publication No. 2008/0116684 the entire contents of which are incorporated herein by reference. In some embodiments, the laminate 44 can have a size that is approximately equal to or just slightly smaller than the area of the first major surface 34 so that the laminate 44 covers substantially the entire area of the surface 34. In other embodiments, the laminate 44 can have a size relative to the size of the print receptor layer 40 that is greater than that shown in FIGS. 2-4 but still significantly smaller than the area of the first major surface 34.

FIG. 5 illustrates an embodiment of a card 50 that is similar in construction to the card 30. In this embodiment, a print receptor layer 52 (indicated in dashed line) is applied only to an area(s) on the card surface where color printing 54 is to be applied. In other words, the color printing 54 is applied over substantially the entire area of the print receptor layer 52. A laminate 56 (shown in solid line) is applied over the print receptor layer 52 and over the color printing 54. This embodiment maximizes the overhanging distance D of the perimeter edge of the laminate 56 compared to the embodiment illustrated in FIGS. 2 and 3, thereby maximizing the amount of the laminate 56 that is adhered or otherwise bonded directly to the surface of the card substrate or to other material of or on the plastic card 50 other than the print receptor layer 52.

FIGS. 2-3 and 5 illustrate the laminates 44, 56 as being rectangular, such as square. However, other shapes for the laminates are possible. For example, FIG. 7 illustrates a laminate 60 that is circular. Some or all of a perimeter edge 62 of the laminate 60 can extend beyond the perimeter edge 48 of the print receptor layer 40. Laminates that are triangular, oval, parallelogram, trapezoid, pentagon, hexagon, heptagon, and the like, in shape, and laminates that have irregular perimeter edges, are also possible.

The term “plastic card” as used herein is intended to encompass cards that are completely or substantially plastic, as well as cards that have non-plastic or composite components (composite cards) and cards having other formulations that function like the card types indicated above. Cards that are encompassed by the term “plastic cards” often bear printed personalized data unique to or assigned specifically to the intended cardholder, such as the name of the cardholder, an account number, an image of the face of the cardholder, and other data. When the plastic card is a financial card such as a credit card, debit card, or the like, the plastic card can also have an integrated circuit chip and/or a magnetic stripe each of which can store data including personalized data.

Examples of plastic cards can include, but are not limited to, financial (e.g., credit, debit, or the like) cards, driver's licenses, national identification cards, business identification cards, gift cards, and other plastic cards which bear personalized data unique to the cardholder and/or which bear other card information. In one embodiment, the plastic card 30 can be an ID-1 card as defined by ISO/IEC 7810, with a length L of about 85.60 mm (about 3⅜ inches), a width W of about 53.98 mm (about 2⅛ inches), and the rounded corners 38a-d each with a radius of between about 2.88-3.48 mm.

In one embodiment, the plastic substrate of the cards described herein comprises polycarbonate. However, in other embodiments, the plastic substrate of the cards could comprise a polyester such as polyethylene terephthalate glycol modified (PETG), acrylonitrile-butadiene-styrene (ABS), chlorinated polyethylene (PEC), polyvinyl chloride (PVC).

The print receptor layers described herein can be formed of any materials that facilitate the application of the color(s) to the card in a printing process. Many examples of print receptor materials are known in the art. An example of a print receptor layer that can be used includes Unichroma™ print receptor material available from ITW Imagedata of Brantham, Manningtree, United Kingdom. The print receptor material can be, for example, a vinyl polymer, a vinyl acetate polymer, an acrylic polymer, a vinyl alcohol, co-polymers of the foregoing materials, and blends of the foregoing materials. The foregoing resins may also include additives such as wax or silica to help reduce mass transfer of color and to help form a clean perimeter edge-line for the print receptor layer, and/or a UV fluorescent agent. In some embodiments, the print receptor layer can comprise greater than about 50% by weight vinyl resin, while in other embodiments the print receptor layer can comprise from about 50% by weight to about 85% by weight vinyl resin.

The print receptor layer can be applied using any suitable technique. For example, the print receptor layer can be applied using a direct-to-card process using a thermal printhead, using a heated roller, by screen or offset printing, or by ink jet. In some embodiments, the print receptor layer can be applied to the card substrate by the card substrate supplier or by the card substrate manufacturer.

The print receptor layer can be applied in any desired amount that is suitable for adequately receiving the color printing. For example, in one embodiment, the print receptor layer can be applied at a receptor coat weight in a range from about 0.2 g/m² to about 1.4 g/m². In another embodiment, the print receptor layer can be applied at a receptor coat weight in a range from about 0.8 g/m² to about 1.6 g/m². In still another embodiment, the receptor coat weight can be about 0.6 g/m². In still another embodiment, the receptor coat weight can be about 0.2 g/m².

The laminates described herein can be formed of any suitable laminate materials. Examples of laminate materials include, but are not limited to, laminate adhesives such as vinyl polymer, vinyl acetate polymer, acrylic polymer, polyamide resin, polyurethane resin, polyester resin, co-polymers of the foregoing materials, radiation and thermal curable compositions, and blends of the foregoing materials. Prior to application of the laminates, the laminates can be carried on a base film.

The laminates described herein can be applied in any manner known in the art including, but not limited to, using a heated roller, using a hot stamp die, a laminate with pressure sensitive adhesive, or a UV curable laminate adhesive that is applied using heat and/or pressure and then UV cured.

The color printing described herein can be applied using any suitable printing technology. Examples of suitable printing technologies that can be used include, but are not limited to, dye diffusion printing, mass transfer or thermal transfer printing, inkjet printing, silk screen printing, and printing using a laser reactive receptor component.

In one specific non-limiting example, a Unichroma™ print receptor material was applied to a surface of a polycarbonate plastic card substrate. Thereafter, diffusion printing using a printhead was used to print on the print receptor material. A polyester laminate film with an adhesive was then applied over the print receptor material and over the printing, with the edge of the laminate film extending beyond the edge of the print receptor material and the laminate film being adhered to the surface of the polycarbonate plastic card substrate.

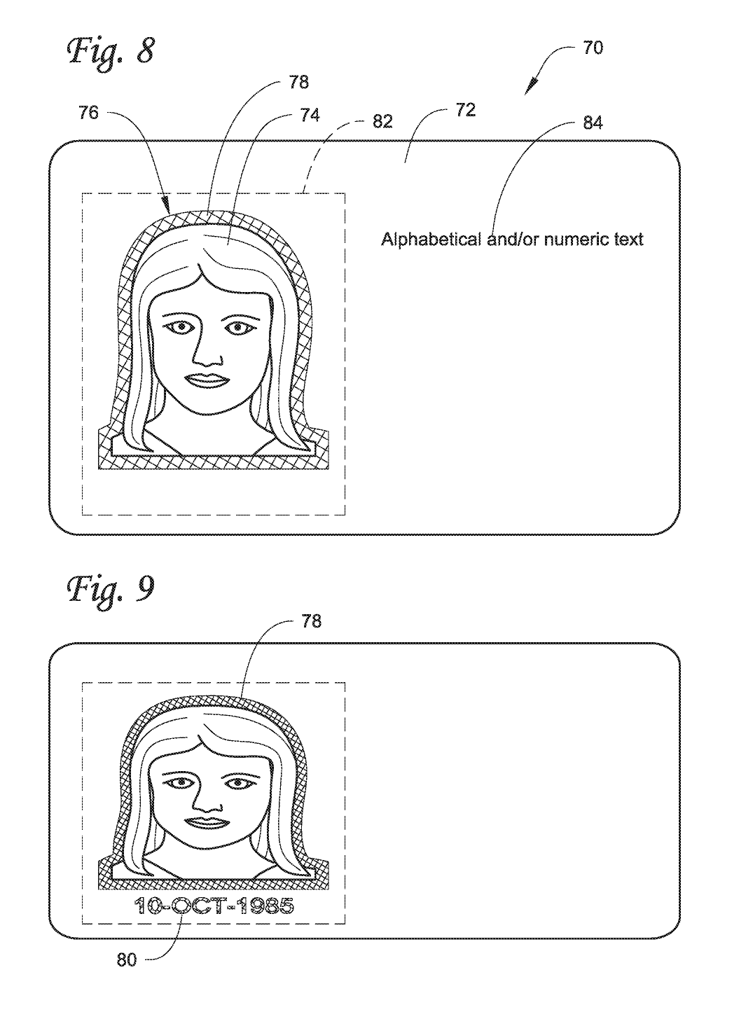

FIGS. 8-11 illustrate embodiments where security features can be created on plastic cards 70 or other plastic identification document substrates such as plastic passport pages. In these embodiments, a material that contains a UV fluorescent agent can be applied, for example by printing, on a surface 72 of the plastic card 70 and the material that contains the UV fluorescent agent forms a border along at least a portion of a printed image. The border can have a perimeter shape that matches or mimics the perimeter shape of the portion of the printed image. When UV light shines on the material containing the UV fluorescent agent, the material forming the border fluoresces or glows.

Referring to FIGS. 8-9, in this embodiment both an image 74 and a material 76 that contains an ultraviolet (UV) fluorescent agent can be applied on the surface 72 of the plastic card 70. In one embodiment, both the image 74 and the material 76 can be applied by printing. The material 76 with the UV fluorescent agent can be a print receptor layer similar to the print receptor layers 40, 52 as described above. The image 74 can be similar to the printed images 42, 54 described above, and can be printed using any of the techniques described above. In this embodiment, the material 76 can be printed in a shape that can be the same as, or substantially the same as, the image 74, but the image formed by the printed material 76 can be larger than the image 74, and the image 74 can be centered on the printed material 76 so that a substantially constant border 78 is created around the entire image 74 wherein the perimeter edge of the image formed by the printed material 76 extends past the perimeter edge of the image 74.

When UV light shines on the printed material 76, the UV fluorescent agent in the printed material 76 forming the border 78 fluoresces or glows thereby creating a unique security feature. The cross-hatched lines in FIG. 8 indicate the fluorescing border 78. When security personnel shine UV light on the image 74 and the printed material 76, if the border 78 is not substantially constant in size and/or does not have a perimeter shape that matches the perimeter shape of the image 74, that can indicate to the security personnel a potential forged card or potential tampering with the card.

At least one of the surfaces of the card 70, such as the surface 72 or the opposite surface, can also include alphabetical and/or numeric text 84 associated with an intended holder of the card. For example, the alphabetical and/or numeric text 84 can include one or more of an account number, expiration date of the card, the name of the intended card holder, an address of the intended card holder, a date of birth of the intended card holder, other biographical data of the intended card holder, and other alphabetical and/or numeric text.

FIG. 9 shows another possible security feature 80 where data, such as alphabetical and/or numeric text, can be formed, for example by printing, using the material 76. When UV light shines on the security feature 80, the UV fluorescent agent in the material used to form the security feature 80 fluoresces or glows. The cross-hatched lines in FIG. 9 indicate the fluorescing border 78 and the fluorescing security feature 80.

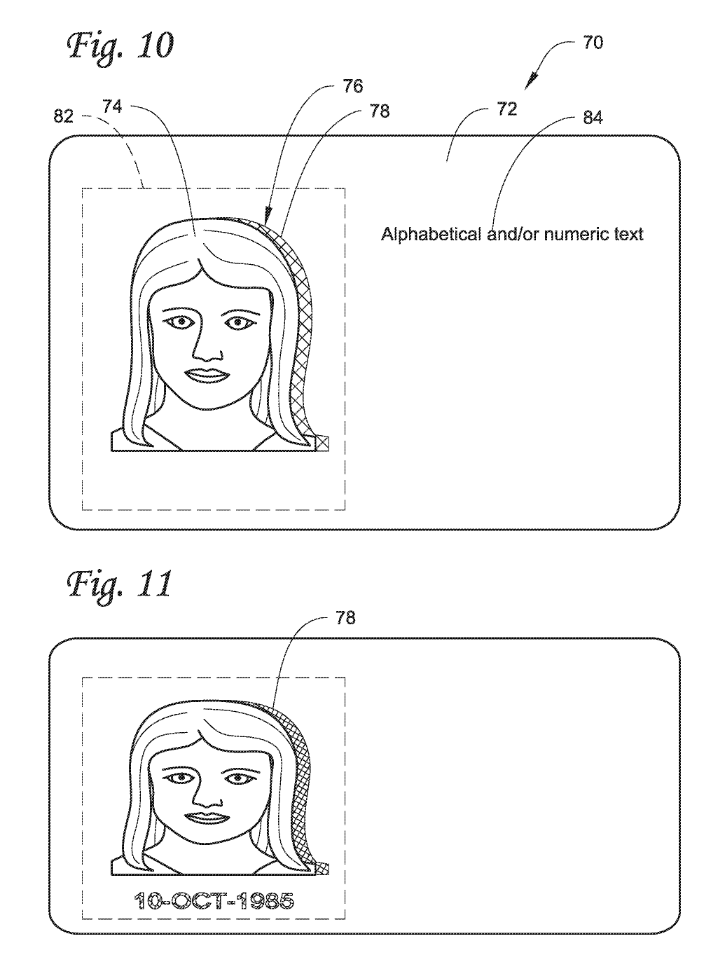

FIGS. 10-11 illustrate an embodiment that is similar to FIGS. 8-9. However, in this embodiment, the image formed by the printed material 76 can be substantially the same shape and size as the image 74, but the image formed by the printed material 76 is slightly offset (for example to the right in FIGS. 10 and 11) from the image 74. In this embodiment, the border 78 is formed along only a portion of the image 74, for example to the right in FIGS. 10 and 11. Accordingly, when UV light shines on the printed material 76, the UV fluorescent agent in the printed material 76 forming the partial border 78 fluoresces or glows. The cross-hatched lines in FIG. 10-11 indicate the fluorescing border 78 and the fluorescing security feature 80.

The border 78 can be formed around any desired length of the image 74. For example, in one embodiment the border 78 could extend along about 25% or more of the perimeter of the image 74. In another embodiment, the border 78 could extend along about 50% or more of the perimeter of the image 74 as in FIGS. 10-11. In still another embodiment, the border 78 could extend along about 75% or more of the perimeter of the image 74. In still another embodiment, the border 78 could extend along substantially the entire perimeter of the image 74 as in FIGS. 8-9.

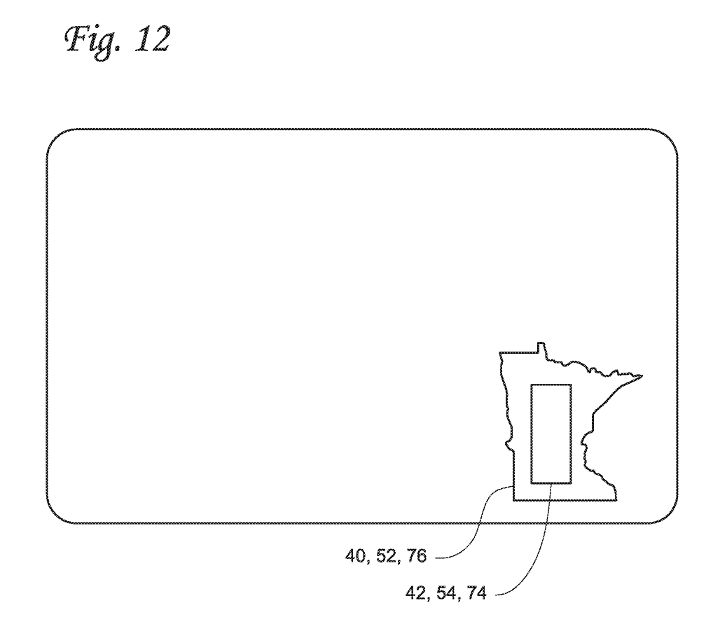

In one possible implementation illustrated in FIG. 12, the receptor layers 40, 52 or the material 76 can be printed or otherwise applied to the surface of the card in a unique shape that is different than the shape of the printed image 42, 54, 74. The printed image 42, 54, 74 can be fully contained within the boundary of the perimeter edge of the image created by the receptor layers 40, 52 or the material 76, or some of the printed image 42, 54, 74 may extend beyond the perimeter edge. For example, as illustrated in FIG. 12, the receptor layers 40, 52 or the material 76 can be applied to have a shape with a perimeter that is shaped in the form of a territorial boundary of a country, region, territory, state, city, or that is shaped in the form of a logo representing a governmental entity or a company. The printed image 42, 54, 74 (shown schematically in FIG. 12) can then be applied over the receptor layer 40, 52 or the material 76, with the printed image either fully contained within the perimeter or border of the receptor layer 40, 52 (or the material 76) or partially contained within the perimeter or border of the receptor layer 40, 52 (or the material 76).

The security features in FIGS. 8-9, 10-11 and 12 can be used without a covering laminate or with a covering laminate 82 (shown in dashed lines in FIGS. 8 and 10) that can be similar to the laminates 44, 56, 60 described above.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A plastic card, comprising:
a card-shaped plastic substrate having a front surface and a rear surface;
a print receptor layer applied to at least a portion of one of the front surface or the rear surface, the print receptor layer having a perimeter edge;
color printing applied to at least a portion of the print receptor layer; and
a laminate applied over at least a portion of the print receptor layer, the laminate has a perimeter edge, and at least a portion of the perimeter edge of the laminate extends beyond the perimeter edge of the print receptor layer.

2. The plastic card of claim 1, wherein 75% or more of the perimeter edge of the laminate extends beyond the perimeter edge of the print receptor layer.

3. The plastic card of claim 1, wherein the entire perimeter edge of the laminate extends beyond the perimeter edge of the print receptor layer.

4. The plastic card of claim 1, wherein the portion of the perimeter edge of the laminate extends beyond the perimeter edge of the print receptor layer by at least 1.0 mm and less than about 10.0 mm.

5. The plastic card of claim 1, wherein the card-shaped plastic substrate comprises polycarbonate.

6. The plastic card of claim 1, wherein the color printing is applied over the entire print receptor layer.

7. The plastic card of claim 1, wherein the card-shaped plastic substrate has a length of about 85.60 mm and a width of about 53.98 mm.

8. The plastic card of claim 1, wherein the color printing forms personalization data that is personal to an intended holder of the plastic card.

9. The plastic card of claim 1, wherein the color printing comprises dye color printing.

10. A plastic card, comprising:
a card-shaped plastic substrate having a front surface and a rear surface, at least one of the front surface and the rear surface including alphabetical and/or numeric text associated with an intended holder of the plastic card;
a receptor layer applied to a portion of the front surface;
a printed image applied over a portion of the receptor layer;
wherein at least a portion of the receptor layer is not covered by the printed image and forms a border around at least a portion of the printed image, the border having a shape that generally corresponds to a peripheral shape of the portion of the printed image, and wherein the receptor layer at the border is ultraviolet active such that the receptor layer at the border fluoresces when exposed to ultraviolet radiation.

11. A plastic card, comprising:
a card-shaped plastic substrate having a front surface and a rear surface, at least one of the front surface and the rear surface including alphabetical and/or numeric text associated with an intended holder of the plastic card;
a printed image applied over a portion of the front surface;
a material containing an ultraviolet fluorescent agent applied on the front surface with at least a portion of the material displaced from the printed image and forming a border along at least a portion of the printed image, the border having a shape that generally corresponds to a peripheral shape of the portion of the printed image; and wherein when ultraviolet light shines on the material at the border the ultraviolet fluorescent agent fluoresces.

12. The plastic card of claim 11, wherein the material comprises a print receptor layer, and the printed image is applied over a portion of the print receptor layer.

13. The plastic card of claim 11, wherein the material has a perimeter shape that is the same as a perimeter shape of the printed image, the perimeter shape of the material is larger than the printed image and the printed image is centered on the material so that a substantially constant border is created around the printed color image by the material.

14. A method of processing a plastic card, comprising:
applying a print receptor layer to at least a portion of one of a front surface or a rear surface of a card-shaped plastic substrate, the print receptor layer having a perimeter edge;
applying color printing to at least a portion of the print receptor layer; and
applying a laminate over at least a portion of the print receptor layer so that at least a portion of a perimeter edge of the laminate extends beyond the perimeter edge of the print receptor layer.

15. The method of claim 14, comprising applying the laminate so that 75% or more of the perimeter edge of the laminate extends beyond the perimeter edge of the print receptor layer.

16. The method of claim 14, comprising applying the laminate so that the entire perimeter edge of the laminate extends beyond the perimeter edge of the print receptor layer.

17. The method of claim 14, wherein the portion of the perimeter edge of the laminate extends beyond the perimeter edge of the print receptor layer by at least 1.0 mm and less than about 10.0 mm.

18. The method of claim 14, wherein the card-shaped plastic substrate comprises polycarbonate.

19. The method of claim 14, comprising applying the color printing over the entire print receptor layer.

20. The method of claim 14, wherein the card-shaped plastic substrate has a length of about 85.60 mm and a width of about 53.98 mm.

21. The method of claim 14, wherein the color printing forms personalization data that is personal to an intended holder of the plastic card.

22. The method of claim 14, wherein the color printing comprises dye color printing.
